(19) United States
(12) Patent Application Publication
(10) Pub. No.: US 2025/0064028 A1
(43) Pub. Date: Feb. 27, 2025

(54) DEVICE, SYSTEM AND METHOD FOR THERMAL TREATMENT OF POLLINATING INSECTS

(71) Applicant: Beefutures Holding AS, Oslo (NO)

(72) Inventor: Christophe Philippe Brod, Oslo (NO)

(21) Appl. No.: 18/724,168

(22) PCT Filed: Dec. 16, 2022
(86) PCT No.: PCT/NO2022/050310

§ 371 Date: Jun. 25, 2024

(30) Foreign Application Priority Data
Dec. 20, 2021 (NO) 20211549

(51) Int. Cl. A01K 47/06; A01K 51/00

(52) U.S. Cl. CPC A01K 47/06; A01K 51/00; A01K 2227/706

(57) ABSTRACT

The invention provides a heating device for thermal treatment of a hive structure adapted for pollinating insects comprising at least one a heating element, and a heat dispersion element comprised of a heat-conducting material at least partly surrounding the heating element or parts thereof, wherein the surface area of the heating dispersion element is larger than the surface of the area of the heating element.

### FIELD OF THE INVENTION

The present invention relates to a system and method for heat treatment of pollinating insects. More specifically it relates to a heating device, heating system and method to mitigate infestation with varroa destructor mites.

### BACKGROUND OF THE INVENTION

The number of bees in the world is dropping dramatically each year and estimates show that up to a third of Europe's bee population and a fourth of Europe's bumble bee population are endangered. Given that bees pollinate around one-third of food crops and 90 percent of wild plants, the consequences of this ecological disaster are alarming for biodiversity, the food chain and, not least, our ability to feed ourselves. The bee's pollination contributes to up to 30% of the world's fruit and vegetable production and animal feed for grazing animals. A reduction in bee population is thus a sharp reduction in food production.

Studies have shown that a combination of neonicotinoids exposure, pollution, lack of food, decrease of biodiversity and biological variation in farmed areas, climate change and the increase of hostile enemies such as the parasitic mite varroa destructor, herby called varroa mite, and the Asian hornet Vespa Velutina are all contributing to the bees decline in population, however, the deadly varroa mite might be considered their number one killer.

The varroa mite is a parasite that attaches to honeybees and prays on the host bee by feeding on the insect hemolymph and body fat. The effect of the varroa parasite on the bee is reduced energy and the introduction of different viruses and diseases causing death to bees as well as whole colonies. Female mites enter beehive structures and lay eggs on the bee larvae inside the brood cells. New bees are emerging from its cells as a hose for the varroa mites, often with defects such as useless wings or viruses and fungi. The varroa mite often leaves its first young host for an older healthier host, causing even more death and demise of the entire colony.

As the negative economic impact of the varroa mite can be devastating for a beekeeper, huge resources have been put into treating and eradicating the varroa mites. One method is to treat the hive structure to toxins such as oxalic acid or formic acid. These substances are highly toxic and even fatal to humans if ingested. There is therefore a need for other methods for treatment against varroa mites. One of the common alternatives to chemical treatment is thermal treatment. Heat treatment has less negative impact on the bee's immune system than acaricides such as formic or oxalic acid. Heat treatment has the potential to less negatively impact the bee's immune system than acaricides such as formic or oxalic acid, as it has been observed that pathogen titers in bees increase after treatment with formic acid. It is also known that a variety of viruses do not resist at elevated temperatures above 38 C°.

Thermal treatment, or hyperthermia exposure, of varroa mites is based on the principle of difference temperature tolerances between the varroa mite and the bee. The varroa mite prefers a generally cooler climate, higher temperature causes high stress on the varroa mite. At a certain point and for a certain amount of time, the varroa mite's ability to reproduce is compromised and at a higher point and duration it will die fairly rapidly if the temperature reaches a certain temperature for a period of time. One method is to cover an infected hive with an enclosed heating box or blanket to heat up the entire hive. This solution is not very effective as the bees, although they will survive, do not like the elevated temperature, and will start to thermoregulate the brood area by vibrating their wings and circulating air around, to keep the temperature comfortable. The other normal approach to thermal treatment is to remove the brood frame from the hive and place the frames with the brood and the infected larva inside a heating container. This method is not very effective for multiple reasons, 1—many bees are not carried over into the container and do not get treatment, 2—varroa mites crawling in the hive are not eradicated, 3—the frame transfer after treatment compromises relative humidity and jeopardize the safety for larvae, 4—and it is but highly labor intensive and time consuming as a beekeeper must manually remove the frames from the hive and store them in a heat box and reverse the process again when complete. Additionally, during the method some mites are likely still crawling in the hives or attached to foraging bees while treating the frames, which decreases the efficiency of the method.

Patent application WO 2017/210410 A1 discloses a hive body with a slotted entrance and an electrical heating tray inserted through the slotted entrance and situated on the floor of the hive. The heating tray comprises a flexible rubber heating pad and overlaying metal plates (61 and 62), so the heating element (20) itself is flexible. There are several major problems with this solution: 1—the heating element is brought inside the living space of the bees, it risks to reach excessive heat points inside the hive, compromising the safety of bees, larvae and wax can easily melt. 2—the solution lacks a temperature fuse controller in the base of the frame to guarantee that harmful temperatures are not reached 3—the heating element is brought manually and the hive is sealed manually, many bees stay outside of the hive and do not get treatment. The solution imposes lower power to avoid harmful temperatures inside the hive, in turns the treatment takes much longer and can compromise bee and larvae health. Moreover this solution requires a relatively large opening required to accommodate a sufficiently sized heating element. The larger the width of the heating element the larger the width of the opening, thus the increased heat loss. Furthermore, this method is labor intensive as it requires the manual interference of manually closing and/sealing the hive, the beekeeper needs to be in close proximity during the treatment and then manually open the hive after treatment, all of which would be severely time consuming as one hive could take as much as 5 hours. It makes it practically impossible to treat in a regular basis Furthermore, the temperature of the heating plate 61 will reach the same temperature as the heating pad 63, which can reach 232° C., and when directly exposed to, and accessible by, the bees it will cause great harm to the bees if they get close or touches the plate 61.

Patent application U.S. Pat. No. 2,506,118 A1 discloses a hive compartment comprising a heating unit to keep colony alive and healthy during the winter, the hive comprising top, bottom and side wall and a heating unit adapted to be secured within said hive to one of the walls. The heating elements require either to be fabricated inside constructional elements of the hive body, rendering the high cost and complexity as it requires replacing the hive body/brood box. Other methods such as disclosed in EP 3042559 B1 teaches hives where a frame is replaced with a heating element. Such a solution is not energy efficient as the heat will be concentrated around one frame and effectively cooled down by the bees themselves. For this method to be efficient all the frames would have to be replaced, which would be costly and time consuming.

Document US 2017/0360010 A1 discloses a beehive 200 that comprises heating elements 222 to generate heat in order to raise the temperature. The temperature in the hive is regulated based on optimal temperature for the bees and not for heat treatment against mites.

US 2017/0360010 A1 discloses a separate contraption for reducing mite infestation in section which includes capturing the queen to prevent the queen from laying eggs and thus stop mite reproduction in the hive. The heating elements 222 are situated in the hive and are in direct contact with the inside of the hive, which is not optimal for heat treatment against mites, as the temperature needed would be dangerous for the bees.

Document U.S. Pat. No. 3,994,034 B A discloses a beehive heater for installation between the lower brood chamber and the bottom board of a standard beehive for protecting a colony during the winter (Abstract). The heating element 46 comprises resistance wire 49 mounted on notched racks 48 to form a continuous heating filament. Heating element 46 is designed to operate at a relatively low temperature having a minimum of radiant energy (column 4, line 30-34). The hive comprises a top panel 34 over the heating element comprising holes 41 for rising heat, wherein the bees are limited to move above the top panel 34.

The solution disclosed U.S. Pat. No. 3,994,034 B is not suitable for heat treatment against mites as the temperature would be too low because the small and few holes in the top cover would not allow sufficient heat to rise into the hive.

Document U.S. Pat. No. 9,807,985 B2 discloses a solution to a prevention of buildup condensate and mold on the inner surface of the beehives caused by temperature and humidity conditions. A heating element 15 is placed on the bottom of a hive wherein two fans 3, 4 circulates air past the heating element 15 and through the hive. The heating element 15 is exposed to the ambient air and the bees.

None of the disclosed documents are suitable for treating mites as the heating elements are directly accessible by the bees and the temperature required to eliminate mites is not possible to achieve with the disclosed solutions without exposing the bees to danger.

Document DE 102016 106992 B3 discloses a solution for combating varroa mites initially comprises a housing which is open on one side, in particular on its upper side, for example a cuboid housing, wherein a heating device for heating the interior of the beehive is arranged within the housing. The heating device 06 is arranged inside the housing 03 for generating heated air and comprises an electronic heating mat extending parallel to the housing opening. To disperse the heat a fan 07 is used.

Document DE102006021144B3 discloses a solution a solution for long term treatment against mites in a beehive using heat and evaporation of hazardous liquids comprises a beehive with the opening for bees in the top and a heating plate on the bottom, the bees are protected from the flat heating plate 111 by a grid 10.

The downside of the known solutions is that the heating elements may be situated inside the living area of the bees, and that the temperature achieved is too low. The known solutions have insufficient power to heat up the hive to the necessary target treatment temperature in a reasonable time when the outside temperatures are low. Taking too long to raise temperature is stressful for the bees, it compromises relative humidity levels inside the hive and can damage larvaes and bee frames soften to the core, risking detachment from the metal wires.

### SUMMARY OF THE INVENTION

As the temperature needed to treat bees from mites is higher than the optimal temperature for bees, it is an aim of the present invention to be able to reach the necessary high temperature in a short duration. The treatment temperature needs to be introduced in the hive air and within the brood area combs in the wax in order to kill both foretic varroas riding bees and crawling inside the hive and the reproductive varroas hidden in comb cells.

It is an aim of the present invention to enable repetitive heat treatment without creating handling work for beekeepers, the invention may provide fully automation and programs heat treatment intervals. The schedule can be interrupted, and beekeepers can also launch treatment manually as well.

It is desirable that the heating device may provide relatively high power. If the heating device is not able to deliver the necessary power to heat up the hive to the target treatment temperature in a reasonable time when outside temperatures are low or when honey density is very high, it will take too long to raise temperature which is stressful for the bees, and bee frames soften to the core, risking detachment from the metal wires. In fact, time to reach treatment temperature is variable and highly depends on colony size, outside temperatures and wind conditions, state of honey storage, inside temperature and state of the brood. The target treatment temperature and duration are also depending on the state of the brood. In spring and summer, during the high brood rearing period, the temperature needs to rise inside the comb cells and in the air. In fall, when there is no brood, it is sufficient to raise temperature of the air only to kill the phoretic mites

With a power output from the heating elements of at least 120 Wh to 360 Wh, and more preferably around 240 Wh, the inside temperature of the hive will be brought up to a target temperature in a timely fashion that reduces stress on bees and guarantee suitable relative humidity inside the hive for the safety of larvae. A powerful system is required to cope with the variability of the colony size and state, the level of storage and weather conditions. relatively quickly. The challenge with a 240 Wh output is that the surface temperature of the heating element can reach 110° C. or above, which can be harmful for bees, wax, and the equipment itself. To disburse the heat and reduce the exuded surface temperature, the present invention uses heat dispersion elements at least partly enclosing or surrounding the heating elements. With the solutions disclosed herein, a device and system capable of providing sufficient power but with a safe surface temperature at the bee floor level, is achieved. The system may be equipped with one or more temperature sensors, wherein one may function as a fuse placed 2 to 8 cm above the beefloor and close to the bottom of the frames, and wherein a second sensor placed on top of the frames of the brood box acting as the regulator. The fuse sensor guarantees that temperature at the very bottom of the frames does not exceed a predetermined temperature at any given time, and the sensor on top provides the command target for the treatment. Wherein the target temperature for treatment in an embodiment, may be between 38 degC and 47 degC, preferably between 41 degC and 44.5 degC, even more preferably between 42 and 43.5 degC.

It is a further aim of the present invention to treat pollinating insects against disease in relation to parasite and parasitic varroa mites and to eradicate the mites from a hive or colony without the drawbacks mentioned above. It is further an aim to increase the treatment efficiencies and the energy efficiency of the treatment compared to known solutions and to reduce the amount of manual labor needed. The present invention also offers the ability to repeat the treatment without harming the bees, thus ensuring the best alternative to keep infestation at bay. The invention enables remote activation of the treatment, or automated schedule.

The invention aims at treating both phoretic and reproductive varroas inside a beehive. The invention proposes therefore an arrangement to keep all bees inside the beehive during the heat treatment for a given period of time.

The invention is set forth and characterized in the main claims, while the dependent claims describe other characteristics of the invention.

It is thus provided a heating device for thermal treatment of a hive structure adapted for pollinating insects comprising at least one a heating element, and a heat dispersion element comprised of a heat-conducting material at least partly surrounding the heating element or parts thereof, wherein the surface area of the heating dispersion element is larger than the surface of the area of the heating element.

In one embodiment the at least one heating element is comprised of one or multiple a printed circuit board to provide heat, wherein a circuit board comprises conductive tracks comprising a trace metal material, said conductive tracks being in electric connection with a voltage source.

In another embodiment, a surface of the heat dispersion element comprises at least a first surface area horizontally aligned and at least a second surface area aligned at an angle to the horizontal plane.

In yet another embodiment the heat dispersion element comprises at least a top part with a continues surface comprises at least a first section at a first height, and a second section a at a second height, wherein the first height is higher than the second height, wherein the first and second sections repeatedly alternate along a longitudinal axis, and wherein the at least one heating elements is situated at least partly under both the first and second sections.

In yet another embodiment the heating device comprises multiple heating elements spaced apart, the heating elements is at least partly surrounded by a common heat dispersion element at least partly surrounding the heating elements.

In yet another embodiment the heat-conducting material is metal.

In yet another embodiment the metal is aluminum, copper or a combination of aluminum and copper.

In yet another embodiment the heating device further comprises a separation element, wherein the separation element separates the pollinating insects from a heating element, the separator element is situated a distance above the heating element, and wherein

In yet another embodiment the separation element is comprised of a plate element comprising through ways that allows heat and air to rise through the through ways and prevents pollinating insects from entering through the through ways, thereby separating the pollinating insects form the heating element.

In yet another embodiment the separation element is a meshed element and the through ways are the opening in the mesh.

In yet another embodiment the heating device is insertable and removable that may be inserted or removed in or from a bottom board or bottom section of a hive, the drawer comprises isolated side walls and floor.

It is further provided a removable heating device comprising a heating device and wherein the removable heating device further comprises insulated side walls and/or floor adapted to hold and isolate the heating device, at least a voltage source, an inspection tray, and protrusions corresponding to shelf like portions to support the device.

It is further provided a system for thermal treatment of a hive structure adapted for pollinating insects comprising an entrance chamber box adapted for positioning below a at least one hive compartment box, wherein the entrance chamber box comprises an entrance for pollinating insects to enter and exit the hive structure, and a device in accordance with any of the claims 1 to 11, wherein the heating device is insertable in, and removable from, the entrance chamber box.

In another embodiment, the entrance chamber box comprises multiple longitudinal slated elements above the entrance.

In yet another embodiment the entrance chamber box comprises a gate system adapted to be operable to fully or partially close the entrance of the entrance chamber compartment box and to open said entrance if closed or partially closed, the closable and openable gate system comprises a movable gate member, and at least an actuator connected to the gate member.

In yet another embodiment the gate member has at least two positions, each position respectively corresponding to either opened or closed, and wherein the actuator is adapted to move the gate member between the at least two positions, whereby, in the closed position the gate member is positioned to fully cover the entrance of the entrance chamber compartment box.

In yet another embodiment the gate member has at least one further position, wherein the at least one further position is a partially closed position wherein the movable gate member is positionable as to partially covers the entrance of the entrance chamber compartment box.

In yet another embodiment the gate member comprises a surface for at least a portion of its length, and wherein an actuator may rotate gate member to selectively position the surface or parts thereof in relation to the entrance, wherein the surface is arranged to block, or partially block, the entrance.

In yet another embodiment the surface of the gate member comprises at least a partial circular shaped or semicircular shaped, rotatable around an axis.

In yet another embodiment the system comprises a temperature sensor and/or a humidity sensor and/or a control unit and/or a power supply.

In yet another embodiment the system further comprises an additional temperature sensor, wherein the first sensor is positioned on the top of the compartment box and adapted to control and measure a predetermined target treatment temperature, and wherein the additional temperature sensor is positioned in the entrance chamber bob below the compartment box, wherein the

In yet another embodiment, the system comprises at least one sensor for identifying invasive pests or mites.

The invention also relates to a method for controlling the contamination of invasive pests and mites in a hive comprising a heating device, wherein the method comprises the steps of: a) activating the heating device and thereby raising the internal temperature of the hive structure to a predetermined temperature, and b) keeping the temperature above the predetermined temperature for at least a predetermined time.

In an embodiment of the method, the predetermined temperature in step a) is between 38 degC and 47 degC, preferably between 41 degC and 44.5 degC, even more preferably between 42 and 43.5 degC.

In yet an embodiment of the method the predetermined time in step c) is between 15 min and 240 min, preferably between 45 min and 180 min, even more preferably between 90 min and 150 min.

The invention also relates to a further method for controlling the contamination of invasive pests and mites in a hive structure comprising the system, wherein the method comprising the steps of: a) closing, or partly closing, the entrance of the entrance chamber via the closable and openable entrance member; b) activating the heating device and thereby raising the internal temperature of the hive structure to a predetermined temperature, c) keeping the temperature above the predetermined temperature for at least a predetermined time, d) turning off the heating device and e) open the entrance of the entrance chamber using a closable and openable entrance member.

The invention also relates to a further method for controlling the contamination of invasive pests and mites in a hive structure comprising the system, wherein the method comprising the steps of: a) closing, or partly closing, the entrance of the entrance chamber via the closable and openable entrance member; b) activating the heating device and thereby raising the internal temperature of the hive structure to a predetermined temperature, c) keeping the temperature above the predetermined temperature for at least a predetermined time, d) turning off the heating device and f) open the entrance of the entrance chamber using a closable and openable entrance member.

In an embodiment of the method, the predetermined temperature in step b) is between 38 degC and 47 degC, preferably between 41 degC and 44.5 degC, even more preferably between 42 and 43.5 degC.

In an embodiment of the method, the predetermined time in step c) is between 15 min and 240 min, preferably between 45 min and 180 min, even more preferably between 90 min and 150 min.

In an embodiment of the method, before step a) the humidity level in the hive is measured, and if the humidity level is below 45% or above 75%, the treatment is aborted.

### BRIEF DESCRIPTION OF THE DRAWINGS

FIGS. 1a and 1b shows a slanted view of a hive

FIG. 2 shows a semi exploded view of a hive

FIGS. 3a, 3b and 3c shows a cross section view different embodiments of the heating elements and heat dispersion elements

FIGS. 4a, 4b, 4c and 4d shows different embodiments of an insertable and removable drawer type heat devices

FIG. 5a shows a heating device

FIG. 5b shows an exploded view of a heating device

FIGS. 6a and 6b shows a heating device situated inside an entrance chamber box

FIG. 7 shows an entrance chamber box from a slanted with the heating device exposed

FIG. 8 shows an entrance chamber box from the front

FIG. 9 shows a close-up view of the entrance chamber box seen from the front with the hatch removed and the heating device and closable gate system exposed

FIG. 10 shows and embodiment of the gate member

FIG. 11 shows and embodiment of the gate member

FIG. 12 shows and embodiment of the gate member

FIGS. 13a and 13b shows and embodiment of the gate member in different states

FIG. 14 shows and embodiment of the gate member

FIG. 15 shows a close-up view of the entrance chamber box seen from a slanted view with the hatch removed and the gate system exposed

### DETAILED DESCRIPTION OF THE INVENTION

The following description will use terms such as “horizontal”, “vertical”, “lateral”, “back and forth”, “up and down”, “upper”, “lower”, “inner”, “outer”, “forward”, “rear”, etc. These terms generally refer to the views and orientations as shown in the drawings and that are associated with a normal use of the invention. The terms are used for the reader's convenience only and shall not be limiting. Like numerals on different drawings describe the same feature. Numerals with apostrophe represents an additional feature represented by the same numeral, for instance the number 21 will represent one or the first of multiple or all of the multiples, and the numeral 21′ represents an additional of the same feature, such as a second or multiple of the same feature. It should be understood that the terms pollinating insects or insect pollinators is used for bees, honey bees, bumblebees, Osmia bees and other insects cultivated and managed by humans in hives. And the use of either bee or honeybee is for the reader's convenience only and shall not be limiting. A hive is any man-made structure or artificial nest used to cultivate and manage pollinating insects.

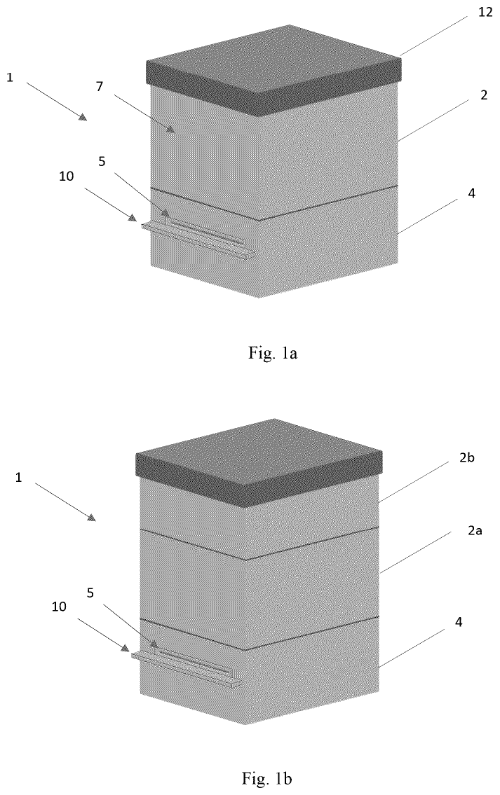

A typical hive, as illustrated in FIG. 1, is typically an artificial nest or structure made to house and keep a colony of pollinating insects such as honeybees, bumblebees, or other insects, for the purpose of producing and harvesting honey, pollinating crops or raise and house bees for other purposes.

Typically, a vertical hive beehive structure comprises at least one hive compartment box for the queen to lay eggs and at least one hive compartment box positioned on top of the first box to store honey. These boxes are sometimes known as brood boxes and honey super boxes, respectively. Typical for these hive compartment boxes is that they comprise four upright quadrilateral wall plates in a quadrilateral layout in a manner forming a four-sided box open in the top and bottom. Inside the box a number of vertical frames are typically hanging or fastened from the top edge portion of two opposing walls. The frames have a height corresponding to, or less than, the height of the wall plates, and a width corresponding to less than the internal width of the box.

The frames are used for holding and storing hexagonal prismatic cells made of honeycomb. The bees use the cells to store honey and pollen in the honey super box, and to house the eggs, larvae, and pupae in the brood box.

In a typical hive there may be between 5-12 frames inside the brood or honey super box each, however any number of frames may be used, which would be obvious to a person skilled in the art. Furthermore, multiple hive compartment boxes may be stacked on top of each other, either with a separating part, such as a queen excluder or other functional separator in between the boxes, or in direct contact. In situations where the production and storage of honey is not the objective, or any other reason for a beekeeper to not store honey, a hive can exist with only one hive compartment box, i.e. no honey super box. The size and dimensions of the hive may vary according to the type of hive used. Hives may typically be constructed from wood, closed-cell expanded polystyrene foam (EPS) or other types of suitable materials such as plastic.

There exist a large variety of different hives, wherein there are two main categories; vertical hooves or horizontal hives. The most typical types of hive honey bees are Langstroth hive, Dadant hive, Warré hive, WBC hives, CDB hives, Perone hives, Norwegian standard hive, UK standard hive and German standard hive. In patent EP 3041349 B1 a list of hives and measurements for the hives are listed in Table 1. All of these hives may be used in accordance with the embodiments of the invention defined in the claims.

Hives adapted for Osmia bees and bumblebees are often of simpler construction than hives adapted for honeybees. Bumblebee hives do not have frames and may comprise of only one hive compartment box and an entrance and exit, and Osmia bees hives comprises multiple holes or tunnels in an otherwise solid construction. It should be understood that the thermal device and system in accordance with the disclosure herein may also be used on hives for bumblebee hives and Osmia bees.

Furthermore, a hive structure may comprise an entrance chamber box, positioned on the bottom of the stack. The entrance chamber box may be a bottom board comprising separate entrance chamber positioned below the at least one hive compartment box, and/or traps and screens for entrance control.

On top of the hive, a cover is used as a roof. Typical covers may be a telescopic cover or a migratory cover that seals the top hive compartment box from rain, cold or heat.

It should be obvious to a person skilled in the art that any combination of number of boxes, compartments, functional disclosures, types and sizes of hives for pollinating insects and honeybees may be suitable for the present inventions disclosed herein.

FIG. 1a illustrates a typical hive 1 structure adapted for housing pollinating insects. The hive structure 1 typically comprises at least one hive compartment box 2 and an entrance chamber compartment box 4 positioned below the at least one hive compartment box 2. The entrance chamber 4 is in contact with at least one hive compartment box 2 and comprises an entrance 5 for pollinating insects to enter and exit the hive structure 1. The inside of the entrance chamber box 4 comprises an open space created by the entrance chamber box walls and a bottom board. The bottom board may be a floorboard type or it may be comprised of a mesh that allows falling mites to go through the mesh of the bottom board. If the bottom board is of the mesh type, there may be an inspection tray 8 beneath the bottom board to collect mites that have dropped from above. The open space leads up to the above situated hive compartment box 2. Attached to the entrance chamber box 4 under the entrance 5 is a landing board 10 for pollinating insects to land before entering the entrance 5. In this case the entrance is a longitudinal cut out in the front wall portion of the entrance chamber box 4. On top of the hive structure is a top cover 12. The top cover 12 is used as a roof. Typical covers 12 may be a telescopic cover or a migratory cover that seals the hive structure 1 from rain, cold or heat, as well as isolate and trap the heat during thermal treatment to increase the efficiency of the method and treatment.

FIG. 1b illustrates a hive structure 1 comprising two hive compartments boxes 2a, 2b. The additional hive compartment box 2b is stacked on top of a first, or main, compartment box 2a, wherein there is an opening between the two compartment boxes 2a, 2b. This configuration is typical when producing honey. Typically, the bottom hive compartment box 2a is the brood box and the top hive compartment box 2b is the honey super box. In other variants (not illustrated) there may be multiple honey super boxes or there may be two brood boxes i.e. the bottom hive compartment box 2a is a brood box and the top hive compartment box 2b is also a brood box.

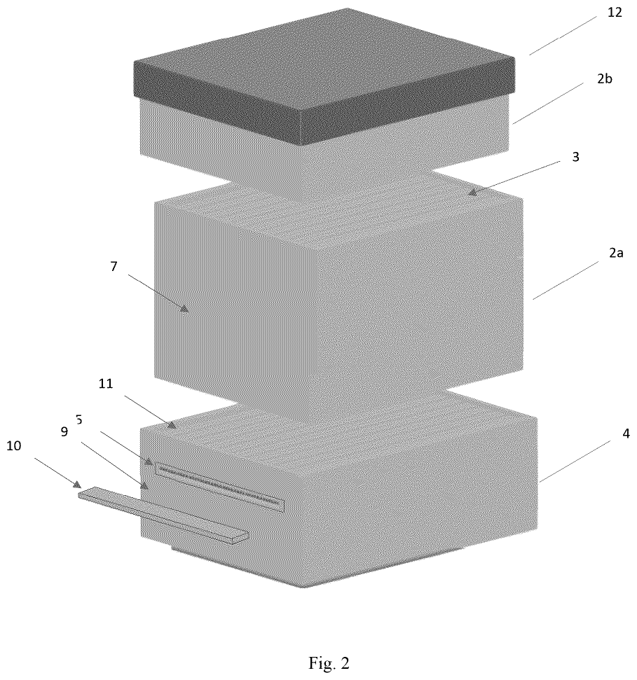

FIG. 2 illustrates an exploded view of a hive structure 1 where the hive compartment box 2 is elevated from the entrance chamber box 4. The entrance chamber box 4 comprises at least the heating device 6 (not shown in the figure). The heating device 6 is in this example positioned in the entrance chamber box 4. When stacked on top of each other the heating device 6 is substantially on the inside of the entrance chamber box 4 and below the entrance 5 of the. Inside the bottom hive compartment box 2a is at least one frame 3 vertically hung.

By having heating device 6 removable, like a like a drawer type device, below the beehive floor, the heating device 6 may be permanently installed or removable installed such that pollinating insects, such as honeybees, can pass to and from the brood frames 3 through the entrance 5 without being hindered by the heating device 6. This permits the heating device 6 to have a width and length longer or wider than the width of the entrance 5 i.e. the heating device 6 does not have to fit in through the entrance 5. Furthermore, by having the heating device removably installed in the entrance chamber box 4 a beekeeper or person managing the hive structure 1 does not have to perform any lifting of the hive compartments each time the heat treatment has to be activated, as the heating device can be operantly installed without causing any hinders or disadvantages to the hive and its occupying swarm.

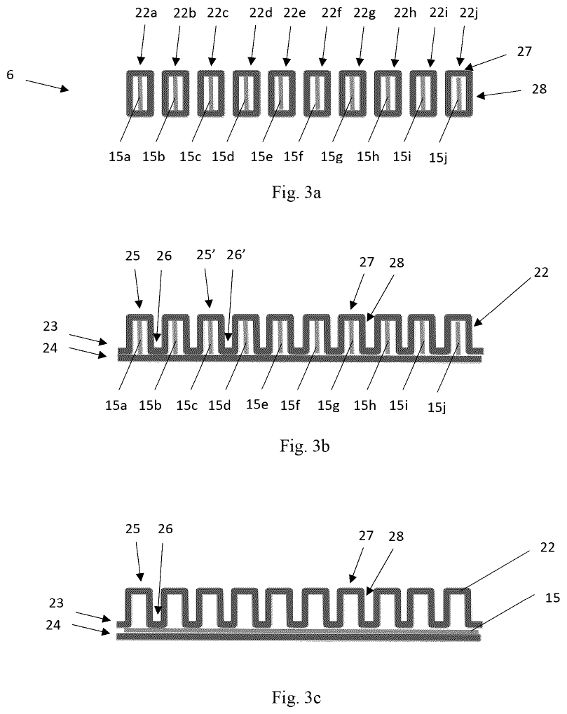

FIG. 3a-3c illustrates a cross section view different embodiments of the heating elements 15 and heat dispersion elements 22, wherein in FIG. 3a the heating device 6 is illustrated with multiple heating elements 15a-15j spaced apart and surrounded by separate heat dispersion elements 22a-22j, each heat dispersion element 22a-22j surrounds respective heating elements 15a-15j. In other embodiments, each respective heat dispersion element 22a-22j may partly surround each heating element 15a-15j. As the figure illustrates a cross section view, the surrounding heat dispersion elements 22a-22j may be tubular shaped. The illustrated embodiment in FIG. 3a has the advantage that it offers the possibility for the the heating elements and/or the heating device to be permanently installed or to form part of a fixed arrangement as the space between the heating elements 15 and thus the space between the eat dispersion elements 22a-22j allows for debris such as dead mites and feces to drop through, and it further improves the heat and air circulation inside the hive.

In FIG. 3b, the heating device 6 is illustrated with multiple heating elements 15a-15j spaced apart and wherein a heat dispersion element 22 at least partly surrounds all heating elements 15a-15j. The heat dispersion element 22 comprises a top part 23, or plate, with a continues surface comprises at least a first section 25 at a first height, and a second section a at a second height 26, wherein the first height is higher than the second height, wherein the first and second sections 25, 26 repeatedly alternate along a longitudinal axis in a trough and peak shape, and wherein respective heating elements 15a-15j is situated below each elevated, or peak section 25. A bottom part 24, that may be flat, of the heat dispersion element 22 may close off the bottom of the enclosing part.

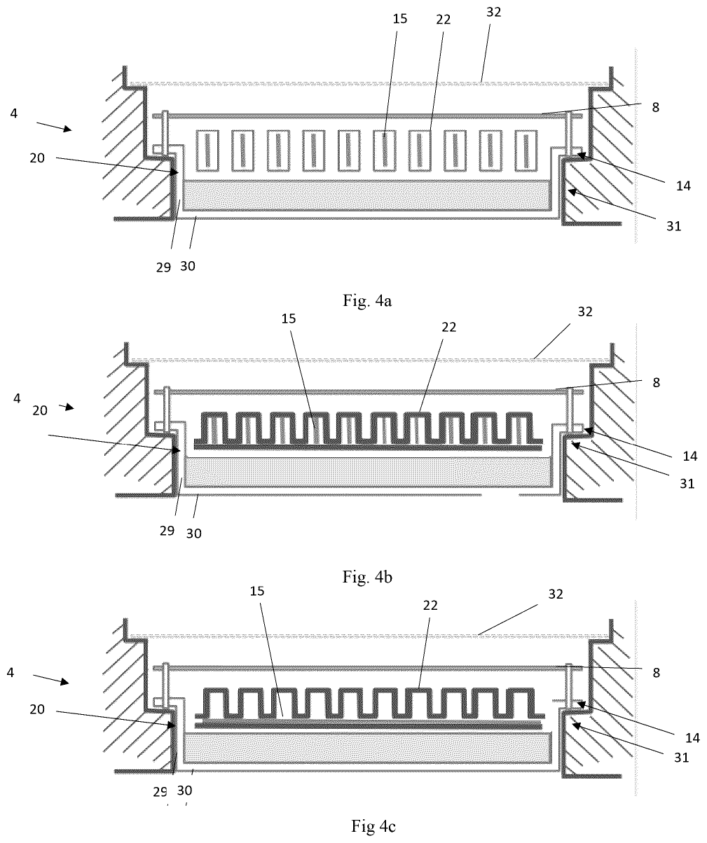

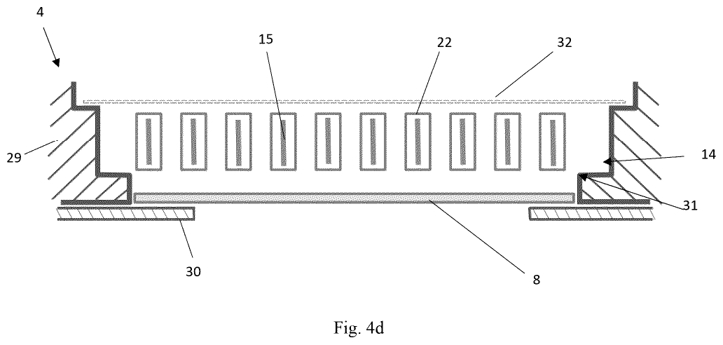

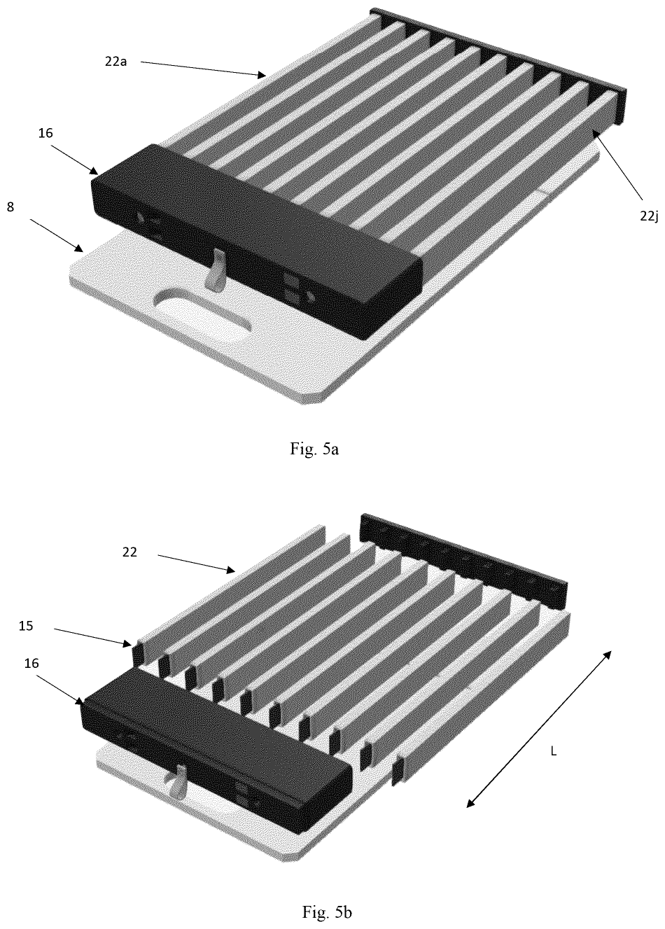

In FIG. 3c, the heating device 6 is illustrated with one heating element 15. The heating element 15 may be relatively flat (seen from the front) with a width and a depth, thereby substantially constituting a plate or plate shape in the horizontal plane. The heat dispersion element 22 comprises a top part 23 with a continues surface comprises at least a first section 25 at a first height, and a second section 26 a at a second height, wherein the first height is higher than the second height, wherein the first and second sections 25, 26 repeatedly alternate along a longitudinal axis in a trough and peak shape, and wherein respective heating element is below the peaks, or first sections 25, of the heat dispersion element 22. A heat dispersion- or insulation plate may be situated under the heating device 6. In another embodiment an inspection tray 8 is inserted under (as seen in FIGS. 4b and 5a) or over the device 6 (as seen in FIG. 4a-4c to catch the dead mites. A beekeeper can remove the tray 8 and count the mites on the tray to determine the number of dead mites, and hence the severity of the infestation. The inspection tray 8 may be a solid plate or the like arranged for collecting droppings, debris, mites and feces.

In FIGS. 3a and 3b the heating elements 15a-15j are each shaped as relatively thin bars or plates with an extent in a longitudinal direction that is not illustrated. In FIG. 3a the combined outside surface area of the heating dispersion elements 22a-22j is greater than the combined surface area of the heating elements 15a-15j, as the heating dispersion elements 22a-22j surrounds the heating elements 15a-15j and will have substantially the same length. In fact, each separate heat dispersion element 22 has a greater outer surface area than each heating element 15. In FIGS. 3b and 3c the alternating trough and peak shape of the heating dispersion element 22 will have a greater area than the combined surface area of the heating elements 15a-15j in FIG. 3b, or the heating element 15 in FIG. 3c, when the heating element and dispersion element have substantially the same extent in the longitudinal direction.

In all the illustrations in FIGS. 3a-3c the heat dispersion element 22 comprises at least a first surface area 27 horizontally aligned and at least a second surface area 28 aligned at an angle to the horizontal plane.

The heating element is preferably comprised of printed circuit board(s) to provide heat, wherein a circuit board comprises conductive tracks comprising a trace metal material, said conductive tracks being in electric connection with a voltage source. A printed circuit board (PCB) is a laminated sandwich structure of conductive and insulating layers. Laminates may be comprised of layers of fiber, cloth or paper curded under pressure and temperature with thermoset resin to form an integral piece of uniform thickness. A conductive trace material is printed or exposed on the board to create a conductive trace. A trace material can then be traced in the PCB with a given length, for instance several meters, and with an inherent electrical resistance in the trance material, the trance material will function as a resistive element when connected to a voltage source. The trace material may be copper, steel, nichrome, chromium or a combination, such as a nichrome wire (80% nichrome/20% chromium). A nichrome wire has a relatively high resistance compared to copper and steel and forms a chromium oxide layer on the outside after its first use, which prevents the element from deteriorating after further uses. Other material may also be used. When using PCB as a heating element for the invention, the surface area of the entire PCB is considered the surface area of the heating element 15. The PCB can be adapted by having different lengths of trace material and materials with different properties to determine the heat characteristics of the heating element 15. Furthermore, the PCB boards can vary in shape and size.

The dispersion element(s) 22 are preferably comprised of a heat-conducting material such as metal, wherein the metal may be aluminum, aluminum alloys, copper or a combination of aluminum and copper.

In FIGS. 4a, 4b, 4c and 4d, a heating device 6 is illustrated as an insertable and removable drawer type device that may be inserted or removed in or from a bottom board or bottom section of a hive 1, the drawer 20 comprises isolated side walls 29 and floor 30. The figures show a cross section of the entrance chamber box 4, wherein the heating device 6 configured in a removable drawer 20 rests on a corresponding shelf like portions 31 of the entrance chamber box 4 inside walls. The removable drawer 20 may comprise protruding notches 14 or corners, protruding from the walls 29, to rest, or be supported on, the shelf like portions 31.

In the illustration in FIG. 4a, the heating device comprises several heating elements 15a-15j and several heat dispersion elements 22a-22j as illustrated in FIG. 3a, comprised of a heat-conducting material at least partly surrounding the heating element 15 or parts thereof. Above the heating and dispersion elements is a separation element 32, wherein the separation element 32 separates the pollinating insects from a heating element, the separator element is situated a distance above the heating element(s) 15 and top surface of the heat dispersion element(s) 22. The separation element 32 is comprised of a separation plate element comprising through ways that allows heat and air to rise through the openings and prevents pollinating insects from entering through the through ways, thereby separating the pollinating insects from the heating element(s). The separation element 32 may be a meshed element and the through ways are the opening in the mesh.

In the illustration in FIG. 4b, the heating device comprises several heating elements 15a-15j and a common heat dispersion element 22, as illustrated in FIG. 3b. In the illustration in FIG. 4c, the heating device comprises one heating element 15 in a plate like configuration, and a common heat dispersion element 22, as illustrated in FIG. 3c. In the illustrations in FIGS. 3b, 3c, 4b, and 4c the heat dispersion element is shown with a distinctly stepped shape; however, it may also be comprised of a wave like shape, or could be individual profiles encapsulating all heating elements individually as illustrated in FIGS. 3a and 4a.

In the illustration in FIG. 4d, the heating device comprises several heating elements 15a-15j and several heat dispersion elements 22a-22j as illustrated in FIG. 3a, comprised of a heat-conducting material at least partly surrounding the heating element 15 or parts thereof. Above the heating and dispersion elements is a separation element 32, wherein the separation element 32 separates the pollinating insects from a heating element, the separator element is situated a distance above the heating element(s) 15 and top surface of the heat dispersion element(s) 22. The separation element 32 is comprised of a separation plate element comprising through ways that allows heat and air to rise through the openings and prevents pollinating insects from entering through the through ways, thereby separating the pollinating insects fromform the heating element(s). The separation element 32 may be a meshed og gridded element and the through ways are the opening in the mesh. In the embodiment illustrated in FIG. 4d, the inspection tray 8 is situated under the heating elements 15 and heat dispersion elements 22 to collect any droppings, debrie, dead mites or the like, that may fall from the hive compartment box 2, passed the separation element 32 and between the adjacent heat and dispersion elements 15, 22.

In FIG. 5a the heating device 6 is illustrated with the heating elements 15 covered by the heat dispersion elements 22. The heating elements 15 are each connected to a voltage or power source 16. The at least one heating device 6 and gate system 17 may be powered by the power source 16, wherein the power source can be at least a battery and/or at least one external power supply in the form of electrical mains and/or at least one power generating device such as an electric generator, windmill or solar cell. Not shown in the figures are the electrical wiring between the electrical components. FIG. 5b illustrates a partly dismantled, or exploded view of, the heating device, wherein the heating elements 15 is seen within each heat dispersion element 22. The length L of each of the heating elements 15 and heat dispersion elements 22 may be any length that may fit inside a typical hive (disclosed in section 29). When discussing the dimension of the heating elements 15, they are discussed with the length being understood as extending in the direction between the front wall 9 of the entrance chamber box and back wall (opposite the front wall). The width of the heating elements 15 are to be understood as the dimension perpendicular to the length L, and the height is the extent in the vertical plane. The same applies to the dimension of the heat dispersion elements. In the embodiment illustrated in FIGS. 3a and 3b, the multiple heating elements are relatively thin in the width direction and with a height that is larger than the width. In the embodiment illustrated in FIG. 3c the single heating element is relatively wide in relation to its height.

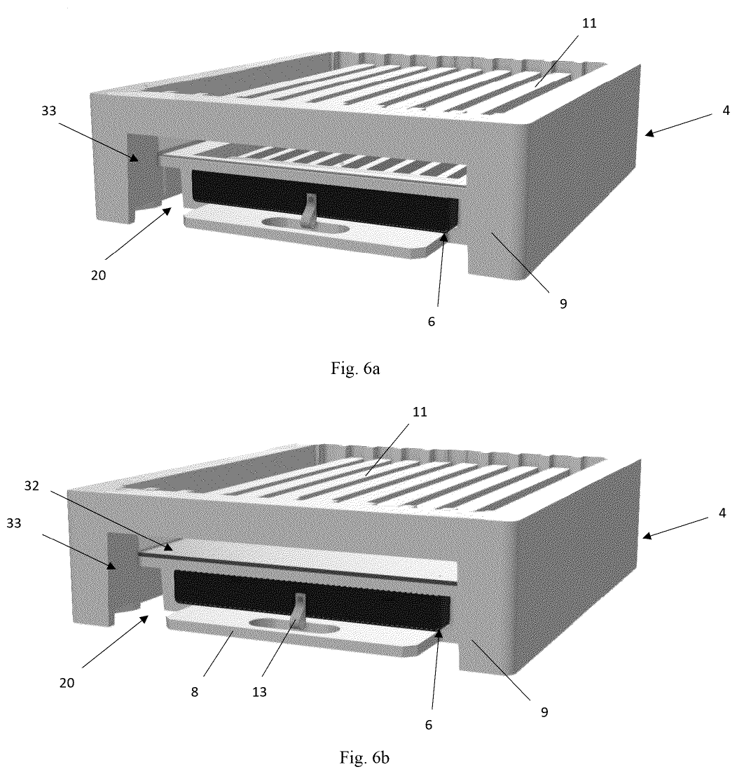

FIGS. 6a and 6b the heating device is situated inside the entrance chamber box 4 below the entrance 5. In these illustrations a front hatch 33 is removed from the front wall 9 to expose the heating device 6 as part of the removable device 20. Above the heating device 6 in the top opening of the entrance chamber box 4, a slatted rack 11 or slates are arranged between the wall boundaries. The heating element(s) is below the hive bee floor (separation element). The slatted rack is above the bee floor, right under the bottom of the frames of the brood box. These may be wooden slats that are adapted to hinder bees from constructing burr combs below the hive frames as they might do if there are open spaces in the hive, and further distances bees from the heat source. Slatted rack also brings several thermoregulation benefits to beehives for winter, when cold air is trapped under the slates, and summer.

In FIG. 6a the heating device is illustrated without the separation element 32 to show the heat dispersion elements 22 surrounding the heating elements 15. In FIG. 6b the heating device is illustrated with the separation element 32 above the heating elements 15 and heat dispersion elements 22. With this installed the bees cannot access the elements below but heat is allowed to rise though openings, such as small holes, in the separator. The openings should preferably be smaller than the pollinating insects.

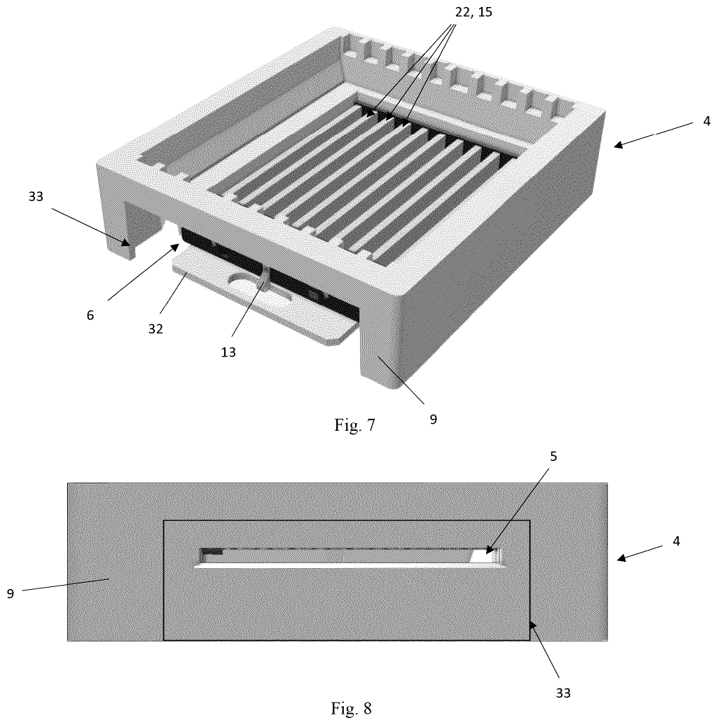

FIG. 7 illustrates the entrance chamber box 4 without the slatted rack 11 to expose the heating device 6 seen from above. The heating device 6 may be removed from entrance chamber box 4 by pulling the pull tab 13 and inserted again. The entrance chamber box 4 is adapted to be fitted to existing hives and the heating device 6 may be fitted or removed whenever necessary without removing any of the hive structures.

FIG. 8 illustrates the entrance chamber box 4 seen from the front of the front wall 9 with the outline of the front hatch 33. The hatch 33 can be opened via hinges or removed completely to expose the heating device 6 and the open and closable gate system 17. To remove the heating device 6 the hatch can be opened, and the heating device 6 and removable device pulled out.

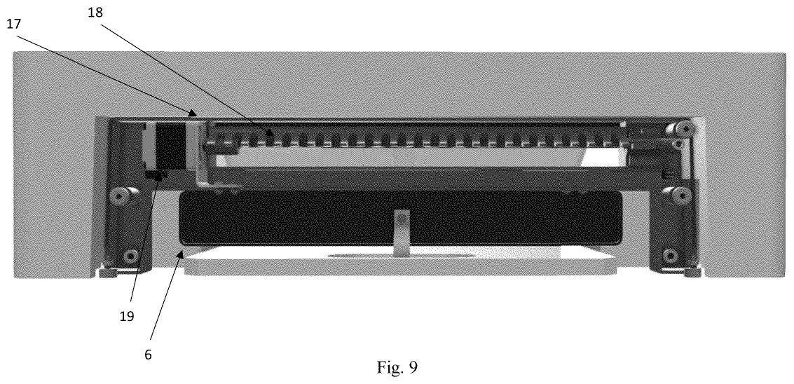

FIG. 9 shows a close-up view of the entrance chamber box 4 seen from the front with the hatch 33 removed and the heating device 6 and closable gate system 17 exposed.

The figure shows an embodiment of the invention where a movable gate system 17 is located by the entrance 5, in this case behind the entrance 5 on the inside of the entrance chamber box 4, however the movable gate system 17 may also be located in front of, or inside the entrance 5. The movable gate system 17 comprises a movable i.e. a closable and openable, gate member 18 adapted to be operable to fully or partially close the entrance 5 of the entrance chamber box 4 by, respectively, fully or partially occupying the entrance 5, and to open said entrance if closed.

The closable and openable system 17 comprises a movable gate member 18, and at least one actuator 19 connected to the gate member 18, to move said gate member 18. The actuator 19 may be any type of pneumatic, hydraulic or electrical actuator of either a linear type or a rotational actuator, where rotational movement is converted to linear movement of the gate member 18 if the gate member is a linear movable gate, or a rotational movement if the gate member is a rotational gate 18. The gate member 18 may pe positioned in at least two positions, each position respectively corresponding to either opened or closed, and wherein the actuator 19 moves the gate member 18 between the at least two positions, wherein in the closed position the gate member is positioned to fully cover the entrance 5 of the entrance chamber compartment box 4. Furthermore, the gate member 18 may have at least one further position, wherein the at least one further position is a partially closed position wherein the movable gate member 18 is positioned so it partially covers the entrance 5 of the entrance chamber compartment box 4, thereby reducing the open area of the entrance. In the reduced position the gate member 18 may be solid i.e. not penetrable but positioned such that a gap or opening 21 is present on one of the sides of the gate member 18. The area of the reduced entrance when in the partially closed position, or the reduced entrance, may be adapted to different purposes. A first possible purpose is a queen excluding purpose, which traps the queen bee inside the hive. This is achieved by predetermining the size of the holes or slits 21 of the gate 18 to let bees through but be too small for the queen, which is of a substantially larger size that the rest of the bees and therefore cannot pass through the openings adapted for the bees, however, the smaller bees may pass. This queen excluder position traps the queen and thereby prevents swarming of the hive. An additional possible purpose of the partially closed position is an area reducing purpose where the holes or slits 21 of the gate member 18 is at a predetermined size that allows all bees including the queen to enter or exit the hive, but larger hostile animals like wasps, mouse and hornets are hindered from entering the hive due to the smaller holes 21 of the gate member 18. Also, for this area reduced purpose bees may allow to enter without exposing to an unnecessary amount of open area to heat loss. In another variant the gate member may comprise a portion with holes 21 of a predetermined size, and the gate member 18 may be positioned as to fully cover the entrance 5 but exposing the holes 21 in the gate member 18, and thereby partially covering the entrance 5.

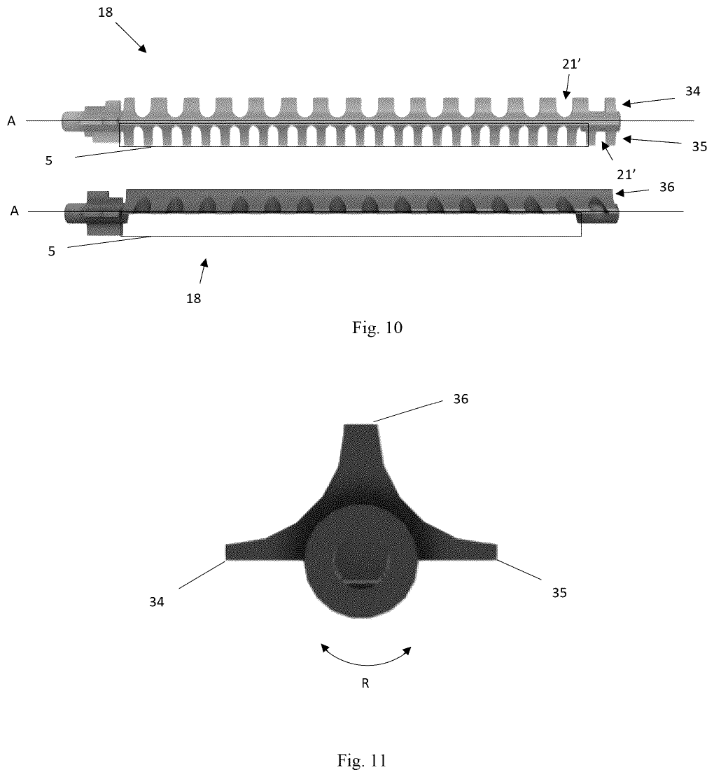

FIG. 10 illustrates an embodiment of the invention wherein the gate member 18 is a member with a longitudinal extent rotatable around an axis A and wherein it may be supported in two opposing ends and wherein the actuator 19 may connected in one of the ends to transfer rotatable movement. In the illustrated embodiment the gate member 18 comprising a surface 37 comprising three gate fan members 34, 35, 36 radiating from the center of the rotatable member. The entrance 5 in the entrance chamber box 4 is illustrated with FIG. 10 to show where the opening 5 may be positioned in relation to the gate member 18. In FIG. 10 the gate member 18 is illustrated in two positions, in the top figure, the second fan member 35 is positioned in front of the opening 5 and the gate system 17 is in the partly closed position. In the lower figure none of the gate fan members 34, 35, 36 are positioned in front of the opening 5 and the gate system 17 is in the open position. Different fan members can be rotated into place in front of the entrance 5. In FIG. 10 the gate member 18 is illustrated with a first gate member 34 comprising large openings 21′, a second gate member 35 comprising smaller openings 21″ that are smaller than the large openings 21′, and a third gate fan member 36 comprising a solid member i.e. without openings.

FIG. 11 illustrates the rotatable member seen from the side wherein three fan members 34, 35, 36 radiates in three different directions. The rotational direction is illustrated with arrow R. If one of these fan members 34, 35, 36 are rotated by the actuator 19, the gate system17 will be at least partly closed stated, wherein the openings 21 in the fan member will determine the state. If the solid fan member 36 is rotated to be in front of the entrance 5, the entrance will be completely blocked and the movable gate system 17 would be in its closed position. If one of the gated fan members 34, 35, 36 is rotated to be in front of the entrance 5 the entrance will be in the partly closed position, either for allowing air to enter and stop all bees, or to allow bees to enter and to exclude the queen bee, or to minimize heat loss and stop bees from exiting during thermal treatment. If the portion of the gate member 18 that has no protruding fan member, for instance the lower part as shown in FIG. 11, is rotated in front of the entrance 5, the entrance 5 is completely unblocked and the movable gate system 17 is in its open position. It should be understood that the gate member may comprise one or multiple fan members.

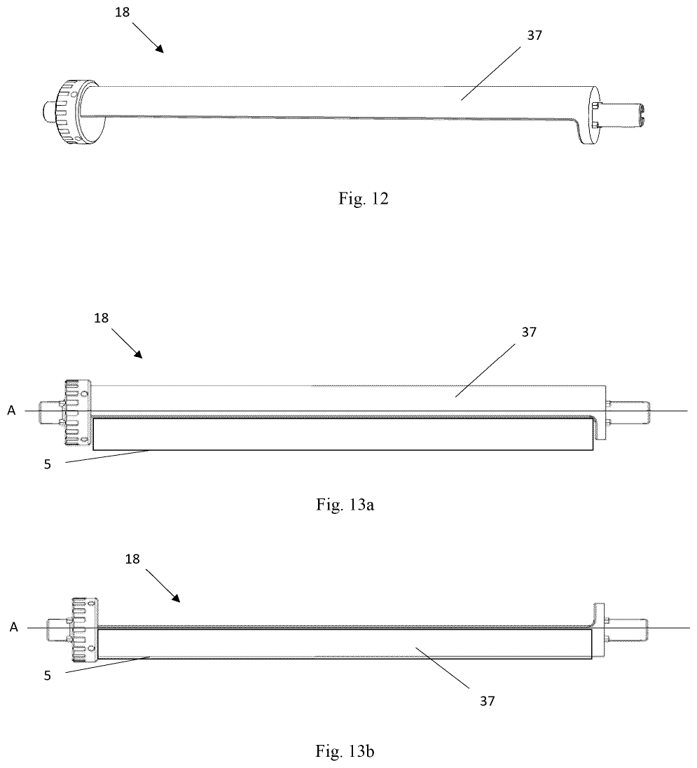

FIG. 12 illustrates an embodiment of the invention wherein the gate member 18 is a member with a longitudinal and rotatable around an axis A and wherein it may be supported in two opposing ends and wherein the actuator 19 may be connected in one of the ends to transfer rotatable movement he gate member 18. In the illustrated embodiment in FIG. 12 the gate member 18 comprises a surface 37 adapted to block, or partially block, the entrance 5, and wherein the surface has a longitudinal extent along the axis A, and wherein the surface of the gate member is at least partial circular shaped or semicircular shaped, such as a half-pipe or the like, rotatable around the axis A.

In FIGS. 13a and 13b the entrance 5 of the entrance chamber box 4 is illustrated to show where the opening 5 may be positioned in relation to the gate member 18 and surface 37. In FIG. 13a the gate member 18 is positioned such that the surface 37 is positioned away from the space of the entrance 5 such that the entrance 5 is not hindered, covered or obscured by the surface 37 and the gate system 17 is in the open position. In FIG. 13b the surface is positioned in front of the opening 5 and the gate system 17 is in the closed position.

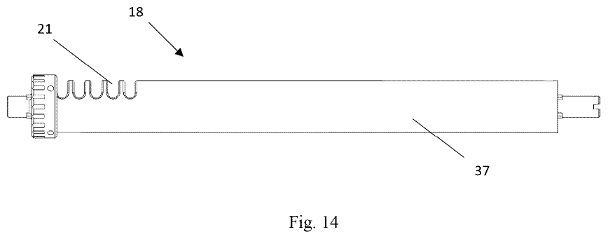

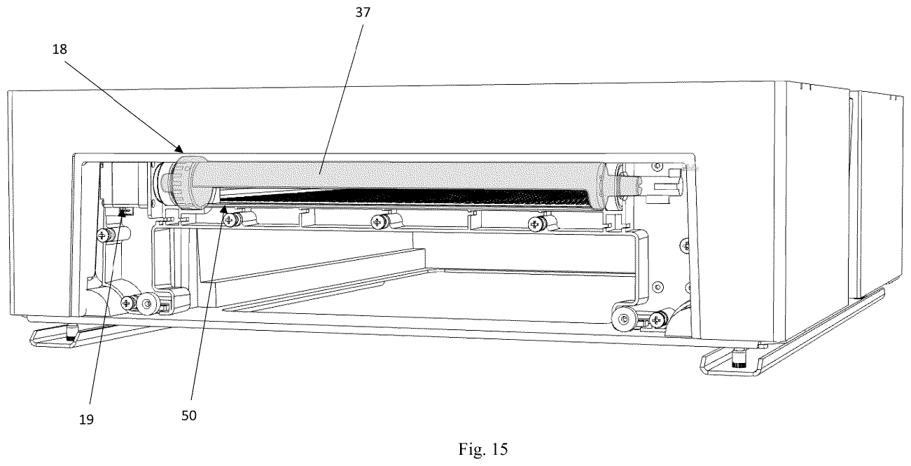

FIG. 14 illustrates an embodiment of the invention wherein the gate member 18 comprises holes, passages or cut out portions 21 in the surface 37, of a predetermined size, and the gate member 18 may be positioned as to fully cover the entrance 5 but exposing the holes 21 in the gate member 18, and thereby partially covering the entrance 5.

FIG. 15 illustrates an embodiment wherein a bottom part of the hive structure is illustrated where a portion of the gate member 18 is seen in the entrance 5. In this illustration the gate member 18 is in a fully open position where surface 37 of the gate member 18 is not in front of the gate. In this embodiment a solid portion of the gate member would result in a completely closed position, if the solid portion fully covers the entrance 5. The closing of the entrance, either fully or partially, is to hold the pollinating insects trapped inside the hive structure for the duration of the thermal treatment or to prevent colonies of bees or other insects from swarming and leaving the hive 1. This ensures that the insects are inside the hive for the required duration. Additionally, this stops airflow and heat loss out of the entrance 5 during treatment. By stopping the heat loss, less effect is needed to reach the required temperatures inside the hive in a desirable timing, resulting in a less stressful event for the bees, less expensive and more environmentally friendly system. An actuator 19 is rotatably connected to the gate member 18, wherein the actuator 19 is in the illustrated embodiment an stepping motor, however, it should be understood that other actuating means may be used, such as linear motors with gearing to translate linear movement tinto rotation.

In a non-illustrated embodiment, the movable gate system 17 comprises a gate 18 that comprises a plate that can be linearly moved in front of the entrance by an actuator. The gate 18 may comprise holes of different sizes to accommodate the different states of the gate system 17. In an embodiment of the invention a bottom board or entrance chamber box may utilize the gate system 17 without the heating device 6 to control the entrance to a hive 1. In this embodiment the gate system will have its own power source. For instance, when the heating device is removed, the gate system 17 and the rest of the functions will still be operable and functionable. In a non illustrated embodiment, the movable gate system 17 may comprise a cylinder shaped gate 18 that comprises a cylinder that can be rotated, by an actuator, to mov different sections of the cylinder in front of the entrance by an actuator. The cylinder gate 18 may comprise holes of different sizes in different sections to accommodate the different states of the gate system 17. The cylinder may in one embodiment comprise a half-cylinder shape, wherein the gate system 17 is in the open position when the half-cylinder part is rotated out of the way of the entrance 5, and wherein the he gate system 17 is in either closed or partially closed position when at least a section of the half-cylinder part is rotated as to be situated in in front of, or behind, the opening of the entrance 5.

In an embodiment of the invention a bottom board or entrance chamber box may utilize the gate system 17 without the heating device 6 to control the entrance to a hive 1. In this embodiment the gate system will have its own power source. For instance, when the heating device is removed, the gate system 17 and the rest of the functions will still be operable and functionable. It should be understood that the gate system 17 and heating device 6 and removable device 20 may be used together or separate in different embodiments.

In FIG. 9 a bottom part of the hive structure is illustrated where a portion of the gate member 18 is seen in the entrance 5. In this illustration the gate member 18 is in a fully open position where the fan members 34, 35, 36 of the gate member 18 are not in front of the gate. In this embodiment a solid portion of the gate member would result in a completely closed position, if the solid portion fully covers the entrance 5. The closing of the entrance, either fully or partially, is to hold the pollinating insects trapped inside the hive structure for the duration of the thermal treatment or to prevent colonies of bees or other insects from swarming and leaving the hive 1. This ensures that the insects are inside the hive for the required duration. Additionally, this stops airflow and heat loss out of the entrance 5 during treatment. By stopping the heat loss, less effect is needed to reach the required temperatures inside the hive, resulting in a less expensive, shorter ramp up time, less stressful overall for the bees, and a more environmentally friendly system.

To be able to remote control the system and treatment thereof, the system for thermal treatment of a hive structure 1 may further comprise at least one temperature sensor to register and monitor the temperature inside the hive structure 1, wherein one may function as a fuse, placed 2 to 8 cm above the beefloor and close to the bottom of the frames, and a second sensor may be placed on top of the frames of the brood box acting as the regulator. The fuse sensor guarantees that temperature at the very bottom of the frames does not exceed a predetermined safe temperature at any time, and wherein the sensor on top provides the target temperature for the treatment To ensure the correct temperature is reached in all areas of the hive structure 1, multiple temperature sensors may be positioned at different locations. The system may also comprise a humidity sensor to sense and measure the humidity inside the hive structure 1 as to monitor the hive during treatment to make sure the treatment is not drying out the hive structure 1 and its content. Heat treatment as disclosed herein in certain embodiments may ideally occur with humidity levels between 50-60% and should preferably be avoided below 45% or above 75%. In an embodiment, the system may comprise a control unit to control the activation and deactivation of the treatment method and/or the heating device dependent on the humidity levels measured by the humidity sensor. The humidity levels disclosed herein should be understood as relative humidity expressed as a percentage, indicating a present state of absolute humidity relative to a maximum humidity given the same temperature. Furthermore, the system may comprise a control unit to control the activation and deactivation of the heating device 6 and/or the movable gate system 17. The control unit may be totally automatic or be accessible to control via an interface by a user. The control unit may be adapted to selectively switching the therapy system on and off to maximize biological response to the light therapy. Crucially, the control unit controls when the therapy system is turned on or off, and for how long the duration of the on- or of-periods should be, and the number of cycles in a predetermined time the on- or off-periods should last. The control unit may be configurable to control parameters for predetermined temperature intervals, wherein said parameters is at least one of; the duration at a certain temperature, the duration of the off-time, the frequency of the intervals, the time of day for turning on, the time of day for turning off. If the required temperature is not reached within a predetermined time, the control unit may signal the gate system to either, partially or fully, close the gate system 17 if the gate system is not already in the closed or partially closed position. In situations where the temperature is sensed by a sensor to be dangerously high, the control unit may open, either partly or fully, the gate system 17. In an embodiment of the invention the control unit for selectable switching the thermal system on or off is remotely configurable via a remote control. The remote-control system may comprise either a wired or wireless transmitting and receiving means. The entrance mechanism comprises a latch function (not shown), that may secure the gate member 18 of the entrance once in the open position to guarantee that the hive entrance stays open if the control unit is down or not responding. A treatment algorithm and fall back actions in the event of max duration or abnormalities, may be handled locally by the control unit of the device itself to avoid communication dependencies and delays in actions.

Furthermore, the device and/or the system may comprise sensors for identifying invasive pests or mites, such as varroa mites, have entered the hive or are attached to the pollinating insects. This sensor can be a camera for visual inspection or determination, or a microphone for audio determination of larger hostile insects.

Furthermore, the device and/or the system may comprise a weight sensor, such as a digital scale to measure the number of bees in the hive or the amount of honey in the hive, which may be preferable in determining characteristics for treatment, such as temperatures and/or duration.

The system as herein disclosed is used in a method for controlling the contamination of invasive pests and mites in a hive structure. The hive structure 1 will comprise a thermal treatment system. The method comprising the steps of first close the entrance 5 of the entrance chamber 4, either partially or fully, using a closable and openable entrance gate system 17. Activating heating device 6, thereby raising the internal temperature of the hive structure 1 to a predetermined temperature. Then keeping the temperature above the predetermined for at least a predetermined time. The predetermined time is in an embodiment between 15 min and 240 min, preferably between 45 min and 180 min, even more preferably between 90 min and 150 min. When the predetermined temperature is held for at least the predetermined time, the heating device 6 may be turned off and the entrance 5 of the entrance chamber box 4 can be opened using the closable and openable entrance gate system 17. Preferably the predetermined temperature to at least raise the temperature inside the hive structure is between 38 degC and 47 degC, preferably between 41 degC and 44.5 degC, even more preferably between 42 and 43.5 degC. The predetermined temperature is in an embodiment controlled and/or measured by at least one temperature sensor to register and monitor the temperature inside the hive structure 1, wherein one may function as a fuse to abort the treatment if the temperature is too high.

Although specific embodiments of the invention have been described and illustrated herein, it is recognized that modifications and variations may readily occur to those skilled in the art, and consequently, that the claims should be interpreted to cover such modifications and equivalents and that the invention is defined by the claims.

### REFERENCE NUMERALS

1 The hive
2 Hive compartment box
2a, 2b Main and top hive compartment box
3 Frames
4 Entrance chamber box, bottom board
5 Entrance in the entrance chamber box
6 Heating device
7 Front wall of hive compartment box
8 Inspection tray
9 Front wall of the entrance chamber box
10 Landing board
11 Slatted rack
12 Top module, top cover
13 Pull tab
14 Protruding notches
15 Heating elements
15a-15j Heating elements 1 to 10
16 Voltage source
17 Gate system
18 Gate member
19 Actuator
20 Drawer device/Removable device
21 Passage(s) in gate member
22 Heat dispersion element
22a-22j Heat dispersion elements 1 to 10
23 Top part of heat dispersion element
24 Lower part of heat dispersion element
25 First section
26 Second section
27 First surface area
28 Second surface area
29 Side walls of removable device
30 Floor of removable device
31 Corresponding support
32 Separation element
33 Hatch/Opening in entrance chamber box
34 First gate fan member
35 Second gate fan member
36 Third gate fan member
37 Blocking surface of gate member

1. A heating device for thermal treatment of a hive structure adapted for pollinating insects comprising:
at least one heating element, and;
a heat dispersion element comprised of a heat-conducting material at least partly surrounding the heating element or parts thereof,
wherein a surface area of the heating dispersion element is larger than a surface of an area of the heating element.

2. The heating device according to claim 1, wherein the at least one heating element is comprised of one or multiple a printed circuit board(s) to provide heat, wherein a circuit board comprises conductive tracks comprising a trace metal material, said conductive tracks being in electric connection with a voltage source.

3. The heating device according to claim 1, wherein a surface of the heat dispersion element comprises at least a first surface area horizontally aligned and at least a second surface area (28) aligned at an angle to a horizontal plane.

4. The heating device according to claim 1, wherein the heat dispersion element comprises at least a top part with a continues surface comprises at least a first section at a first height, and a second section a at a second height, wherein the first height is higher than the second height, wherein the first and second sections repeatedly alternate along a longitudinal axis, and wherein the at least one heating element is situated at least partly under both the first and second sections.

5. The heating device according to claim 1, wherein the device comprises multiple heating elements spaced apart, the heating elements is at least partly surrounded by a common heat dispersion element at least partly surrounding the heating elements.

6. The heating device according to claim 1, wherein heat-conducting material is metal.

7. The heating device according to claim 6, wherein the metal is aluminum, copper or a combination of aluminum and copper.

8. The heating device according to claim 1, wherein the device further comprises a separation element, wherein the separation element separates the pollinating insects from a heating element, the separator element is situated a distance above the heating element.

9. The heating device according to claim 8, wherein the separation element is comprised of a plate element comprising through ways for providing means for heat and air to rise through the through ways and prevents pollinating insects from entering through the through ways, thereby separating the pollinating insects from the heating element.

10. The heating device according to claim 8, wherein the separation element is a meshed element and the through ways are opening in the mesh.

11. The heating device according to claim 1, wherein the heating device is situated in an insertable and removable drawer that may be inserted or removed in or from a bottom board or bottom section of a hive, the drawer comprises isolated side walls and floor.

12. A removable heating device comprising a heating device in accordance with claim 1, and wherein the removable heating device further comprises insulated side walls and/or floor adapted to hold and isolate the heating device, at least a voltage source, an inspection tray, and protrusions corresponding to shelf like portions to support the device.

13. A system for thermal treatment of a hive structure adapted for pollinating insects comprising;
an entrance chamber box adapted for positioning below a at least one hive compartment box,
wherein the entrance chamber box comprises an entrance for pollinating insects to enter and exit the hive structure, and;
a device in accordance with claim 1, wherein the heating device is insertable in, and removable from, the entrance chamber box.

14. The system according to claim 13, wherein the entrance chamber box comprises multiple longitudinal slated elements above the entrance.

15. The system according to claim 13, wherein the entrance of the entrance chamber box comprises:
a gate system adapted to be operable to fully or partially close the entrance of the entrance chamber compartment box and to open said entrance if closed or partially closed,
the closable and openable gate system comprises:
a movable gate member, and;
at least an actuator connected to the gate member.

16. The system according to claim 15, wherein the movable gate member has at least two positions, each position respectively corresponding to either opened or closed, and wherein the least an actuator is adapted to move the movable gate member between the at least two positions, whereby, in the closed position the movable gate member is positioned to fully cover the entrance of the entrance chamber compartment box.

17. The system according to claim 15, wherein the movable gate member has at least one further position, wherein the at least one further position is a partially closed position wherein the movable gate member is positionable as to partially covers the entrance of the entrance chamber compartment box.

18. The system according to claim 15, wherein the gate member comprises a surface for at least a portion of its length, and wherein an actuator may rotate gate member to selectively position the surface or parts thereof in relation to the entrance, wherein the surface is arranged to block, or partially block, the entrance.

19. The system according to claim 15, wherein the surface of the gate member comprises at least a partial circular shaped or semicircular shaped, rotatable around an axis.

20. The system according to claim 13, wherein the system further comprises a temperature sensor and/or a humidity sensor, a control unit and a power supply.

21. The system according to claim 20, wherein the system further comprises an additional temperature sensor, wherein the temperature sensor is positioned on a top of the compartment box and adapted to control and measure a predetermined target treatment temperature, and wherein the additional temperature sensor is positioned in the entrance chamber box below the compartment box.

22. The system according to claim 13, that further comprises at least one sensor for identifying invasive pests or mites.

23. A method for controlling a contamination of invasive pests and mites in a hive comprising a heating device in accordance with claim 1, wherein the method comprises:
a) activating the heating device and thereby raising an internal temperature of the hive structure to a predetermined temperature, and;
b) keeping the internal temperature above the predetermined temperature for at least a predetermined time.

24. The method according to claim 23, wherein the predetermined temperature in step a) is between 38 degC and 47 degC, preferably between 41 degC and 44.5 degC, even more preferably between 42 and 43.5 degC.

25. The method according to claim 23, wherein the predetermined time in step c) is between 15 min and 240 min, preferably between 45 min and 180 min, even more preferably between 90 min and 150 min.

26. A method for controlling a contamination of invasive pests and mites in a hive structure comprising the system according to claim 13, wherein the method comprises:
a) closing, or partly closing, the entrance of the entrance chamber box via a closable and openable entrance member;
b) activating the heating device and thereby raising an internal temperature of the hive structure to a predetermined temperature;
c) keeping the internal temperature above the predetermined temperature for at least a predetermined time:
d) turning off the heating device: and
e) open the entrance of the entrance chamber box using a the closable and openable entrance member.

27. A method for controlling a contamination of invasive pests and mites in a hive structure comprising the system according to claim 13, wherein the method comprises:
a) closing, or partly closing, the entrance of the entrance chamber box via a closable and openable entrance member;
b) activating the heating device and thereby raising an internal temperature of the hive structure to a predetermined temperature:
c) keeping the internal temperature above the predetermined temperature for at least a predetermined time:
d) turning off the heating device: and
e) open the entrance of the entrance chamber box using the closable and openable entrance member.

28. The method according to claim 27, wherein the predetermined temperature in step b) is between 38 degC and 47 degC, preferably between 41 degC and 44.5 degC, even more preferably between 42 and 43.5 degC.

29. The method according to claim 27, wherein the predetermined time in step c) is between 15 min and 240 min, preferably between 45 min and 180 min, even more preferably between 90 min and 150 min.

30. The method according to claim 27, wherein before step a) a humidity level in the hive is measured, and if the humidity level is below 45% or above 75%, the treatment is aborted.
